(19) United States
(12) Patent Application Publication
(10) Pub. No.: US 2018/0316987 A1
(43) Pub. Date: Nov. 1, 2018

(54) CONVERTING DATA FROM ONE PROTOCOL TO ANOTHER ON METROLOGY HARDWARE

(71) Applicant: Dresser, LLC, Addison, TX (US)

(72) Inventors: Roman Leon Artiuch, Houston, TX (US); Francisco Manuel Gutierrez, League City, TX (US); Francisco Enrique Jimenez, Spring, TX (US); Jason Lee Mamaloukas, Cypress, TX (US); Jeff Thomas Martin, Spring, TX (US); Andrew Logan Perkins, Houston, TX (US)

(21) Appl. No.: 15/951,910

(22) Filed: Apr. 12, 2018

Related U.S. Application Data
(60) Provisional application No. 62/490,372, filed on Apr. 26, 2017.

(51) Int. Cl. H04Q 9/00; H04L 29/06

(52) U.S. Cl. CPC H04Q 9/00; G01D 4/004; H04L 69/08

(57) ABSTRACT

A functional board that is configured to accommodate different data protocols for “off-board” communication. These configurations may find use in metrology hardware, for example, utility meters that measures volumetric flow of fluids like gas or water. In one implementation, the functional board may include a circuit board and a pair of circuit cards coupled to the circuit board to communicate with one another using a first communication protocol. The pair of circuit cards may include at least one that is removable from the circuit board and comprises an interface unit that transmits and receives incoming signals in a second communication protocol that is different from the first communication protocol.

### CROSS-REFERENCE TO RELATED APPLICATIONS

This application claims the benefit of U.S. Provisional Ser. No. 62/490,372, filed on Apr. 26, 2017, and entitled UNIVERSAL CONTROLLER, the content of which is incorporated herein by reference in its entirety.

### BACKGROUND

Devices may include specialized “communication” hardware to exchange data with one another. Structure for this hardware often works with protocols that define a data format, for example, rules that set out syntax, semantics, and like structure for the data. Various data formats are known with features or functionality that may benefit certain applications over others. This variability tends to require device designs to tailor components for use with communication hardware that can operate in each, individual application. The result is that devices that work in one application may not readily work in another application because the communication hardware is not able to work with any “new” data format. For industrial devices, wholesale changes to certain parts, typically circuitry, are often necessary to properly align the device to work with different control systems or even to communicate data to different remote computers, tablets, or other “smart” appliances. These changes may require valuable time and resources to design, build, test, and integrate parts that outfit the device with functions to cooperate in its intended application. Once built, though, the resulting hardware constraints limit compatibility of the device, which may complicate inventory and bill-of-materials because of the specificity of designs necessary to meet the wide array of existing and potentially new applications.

### SUMMARY

The subject matter of this disclosure relates to improvements to industrial devices that address these issues. Of particular interest herein are embodiments that can accommodate different protocols or data formats with little to no changes in the underlying hardware on the device. The embodiments may include a replaceable board or card that introduces functionality to translate data from the device's native language to the protocol necessary for external communication, and vice versa. This feature foregoes the need for complex re-design and manufacture to adapt industrial devices from one protocol to another protocol.

### DRAWINGS

Reference is now made briefly to the accompanying drawings, in which:

FIG. 1 depicts a schematic diagram of an exemplary embodiment of a functional board;

FIG. 2 depicts an example of the functional board of FIG. 1;

FIG. 3 depicts the functional board of FIG. 2 with a first adapter in place to define communication functions on the device;

FIG. 4 depicts the functional board of FIG. 2 with a second adapter in place to define communication functions on the device;

FIG. 5 depicts an example of the functional board of FIG. 1 with additional components to outfit the device to collect and process data; and

FIG. 6 depicts a perspective view of an example of metrology hardware that can integrate the functional board of FIG. 1.

Where applicable like reference characters designate identical or corresponding components and units throughout the several views, which are not to scale unless otherwise indicated. The embodiments disclosed herein may include elements that appear in one or more of the several views or in combinations of the several views. Moreover, methods are exemplary only and may be modified by, for example, reordering, adding, removing, and/or altering the individual stages.

### DETAILED DESCRIPTION

The discussion below describes embodiments of industrial devices. These embodiments are configured with communication hardware that diverges from devices-to-date, which tend to have hardware that is purpose built to communicate in accordance with only a specified or prevailing protocol. The configurations herein, however, provide both functional automation and flexibility to streamline interoperability of the embodiments among different protocols and data formats. In many industries, these features create device-level automation that is dynamic because the hardware can readily to adapt to different modalities of communication. As a result, the embodiments may take advantage of advances in data transfer and computing technologies, as well as to facilitate capital improvements or investment in process control systems.

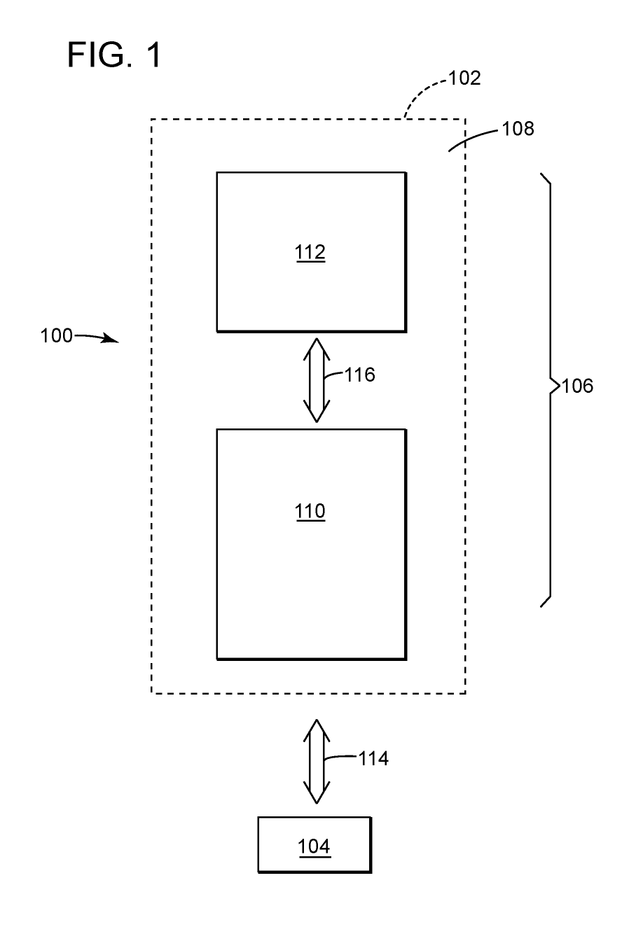

FIG. 1 illustrates a schematic diagram of an exemplary embodiment of a functional board 100. This embodiment may outfit hardware 102, like metrology or process hardware, to communicate with an off-board device 104. The functional board 100 may include a board-level assembly 106 having a base or main board 108 that connects a pair of cards (e.g., a first card 110 and a second card 112). The first card 110 may generate and process signals (e.g., a first signal 114 and a second signal 116). The signals 114, 116 are useful to exchange data between the first card 110 and the off-board device 104 or the second card 112, respectively.

Broadly, the functional board 100 may be configured to easily adapt the hardware 102 for new functions. These configurations may bi-furcate data processing to accommodate use of different protocols (or “languages”) for data exchange that occurs “on-board” and “off-board” the device. In use, this feature permits the hardware 102 to accommodate different protocols for off-board exchange with little added expense to re-design or overhaul the underlying circuitry on the functional board 100. As a result, the hardware 102 can repurpose for other applications as part of processes to assemble or refurbish the functional board 100 (or the device 102) or as part of upgrades or repair, some of which may even occur with the hardware 102 resident in the field.

The hardware 102 may be configured to perform a variety of functions. Metrology hardware may include utility meters, like gas meters or water meters. These meters can generate data to quantify flow of fluids. Processing this data generates values that may find use, for example, to bill or charge customers for fuel. Process hardware may include flow controls, like valves or actuators. These devices may integrate into larger control systems, some of which may control the process hardware to regulate flow of fluids through process lines.

The off-board device 104 may be configured to exchange data with the device 102. These configurations may include devices that allow an end user to send and receive data. Suitable devices may include computing devices, like laptops, tablets, and smartphones. Larger control systems may include a controller that delivers control signals to the device 102 or that retrieves operating data from the device 102. Control signals can cause the device 102 to operate, for example, in accordance with process parameters on the process line.

The board-level assembly 106 may be configured to adapt the device 102 to talk to the off-board device 104. The main board 108 may integrate as a component of operative circuitry found on the hardware 102. This component may have ports or slots to receive and secure the cards 110, 112 to the main board 108. Other configurations may “hardwire” the second card 112 to the main board 108, as desired. On the other hand, the slots may allow the first card 110 to insert into and remove from the board-level assembly 106. This feature allows the main board 108 to accept different ones of the first card 110, essentially where a first one of the card 110 swaps out of the slot in favor of a second one of the card 110. The second one may configure the main board 108 with functions different than the first one, for example, functions that support data in a protocol (or language) that is different from the protocol (or language) supported by the first one.

Topology for board 108 and cards 110, 112 may vary as necessary to achieve its relevant functions. Generally, the topology may include a substrate, preferably one or more printed circuit boards (PCB) with interconnects of varying designs, although flexible printed circuit boards, flexible circuits, ceramic-based substrates, and silicon-based substrates may also suffice. For purposes of example, a collection of discrete electrical components may be disposed on the substrate, effectively forming circuits or circuitry to execute functions on the hardware 102. Examples of discrete electrical components include transistors, resistors, and capacitors, as well as more complex analog and digital processing components (e.g., processors, storage memory, converters, etc.). This disclosure does not, however, foreclose use of solid-state devices and semiconductor devices, as well as full-function chips or chip-on-chip, chip-on-board, system-on chip, and like designs.

The signals 114, 116 may be configured to convey data. This data may include information pertinent to operation of the device 102. For utility meters, the information may define operating parameters (e.g., pressure, temperature, flow, etc.), or “telemetry data,” often that relates to how material transits through the device 102. An end user can leverage telemetry data to confirm operation of the device 102 or troubleshoot problems to provide accurate maintenance in the field. On process devices, like a valve or actuator, the operating parameters may define set point, pressure, or position of a part, typically a result of a sensor or other feedback device.

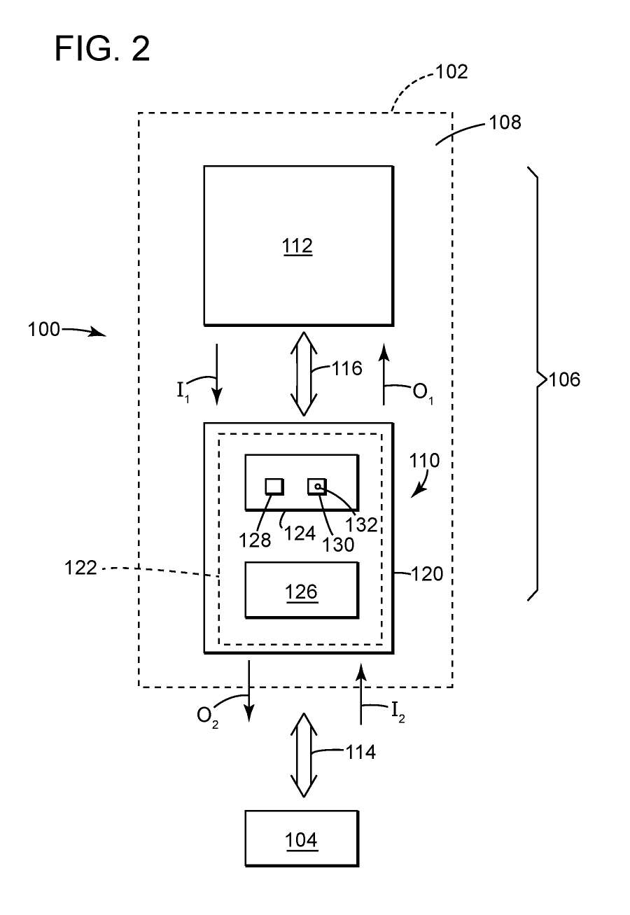

FIG. 2 depicts a schematic diagram of an example of the functional board 100 of FIG. 1. The first card 110 may embody an adapter 120 that outfits the main board 108 for wired or wireless communication with the off-board device 104. The adapter 120 may include circuitry 122 that has a translator unit 124 and an interface unit 126, often coupled with one another to exchange data. For wired communication, the interface unit 126 may embody connectors that accommodate industry standards like universal serial bus (USB), RS-232, and others. The interface unit 126 may employ “wireless” devices like antennas or radios for wireless communications. In one implementation, the translator unit 124 may include computing components, like a processor 128 that couples with memory 130 having executable instructions 132 stored thereon. These computing components may embody stand-alone, discrete devices or, in one example, integrate as part of a micro-controller or like processing component.

The translator unit 124 may make the functional board 100 compatible with the second protocol (I₂, O₂). Executable instructions may embody steps, processes, or functions, for example, that configure the processor 128 to convert incoming data (I) and outgoing data (O) from a first protocol (I₁, O₁) to a second protocol (I₂, O₂), and vice versa. Examples of the first protocol (I₁, O₁) or “native” language may facilitate data exchange between the cards 110, 112 and, possibly, find use for other communications throughout the main board 108. In one implementation, the first protocol (I₁, O₁) may embody Constrained Application Protocol (“CoAP”), although other types and standards may fit the concepts here as well. The second protocol (I₂, O₂) preferably allows data exchange to occur with the off-board device 104 (or, more generally, may comport with requirements of an end user or a target). Some applications may integrate the off-board device 104 as the controller in the control system (noted above). This controller “talks” with the hardware 102 to control its operating functions (for example, to cause an actuator or valve to move). In this setting, the second protocol (I₂, O₂) may embody an “industrial automation protocol,” like MODBUS, PROFIBUS, FOUNDATION Fieldbus, or HART. Protocols like this may serve or function as base-level networking protocols for factory automation. This disclosure also contemplates use of other protocols, e.g., OPC, that define interoperability among devices in the industrial automation space. For wireless data exchange, the second protocol (I₂, O₂) may embody cellular or WiFi protocols, although the design may also benefit from use of shorter-range protocols, like near-field communications (NFC), Zigbee, or Bluetooth, as well.

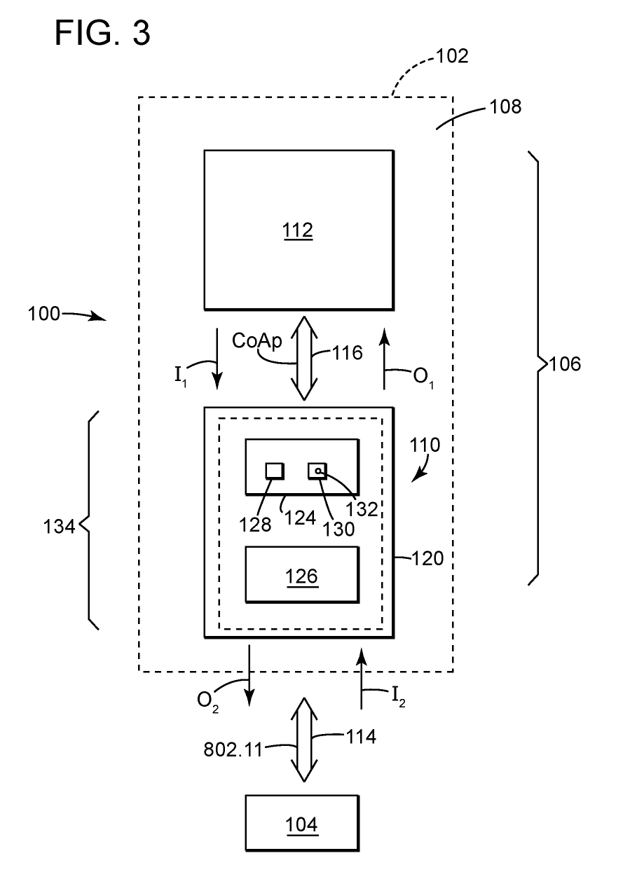

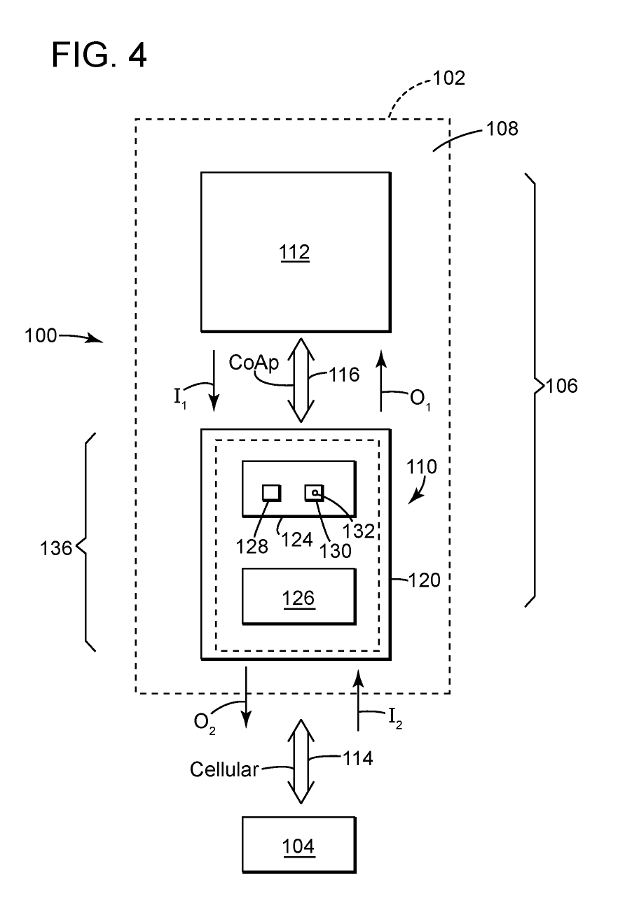

FIGS. 3 and 4 are useful to explain the benefits of the translator 124 to configure the functional board 100 for use between different types of the second protocol (I₂, O₂). In FIG. 3, the adaptor 120 may embody a first adapter 134 that has a first wireless device 126 that may operate in accordance with WiFi standards, like IEEE 802.11. The translator 124 of the first adapter 134 can convert data from CoAP to this WiFi standard, which then broadcasts as the signal 114 outbound from the hardware 102 via the first wireless device 126. When the signal 114 is inbound, however, the translator 124 can convert data from this WiFi standard to CoAP. The data can then transit as the second signal 116 to the second card 112 (or elsewhere on the functional board 100). As best shown in FIG. 4, a second adapter 136 may swap into the board-level assembly 106 in place of the first adapter 134. The second adapter 136 may have a second wireless device 126 that may operate in accordance with Cellular standards. Notably, no other changes to the functional board 100 are necessary because the translator unit 124 on the second adapter 136 can convert data from CoAP to the Cellular standard, and vice versa.

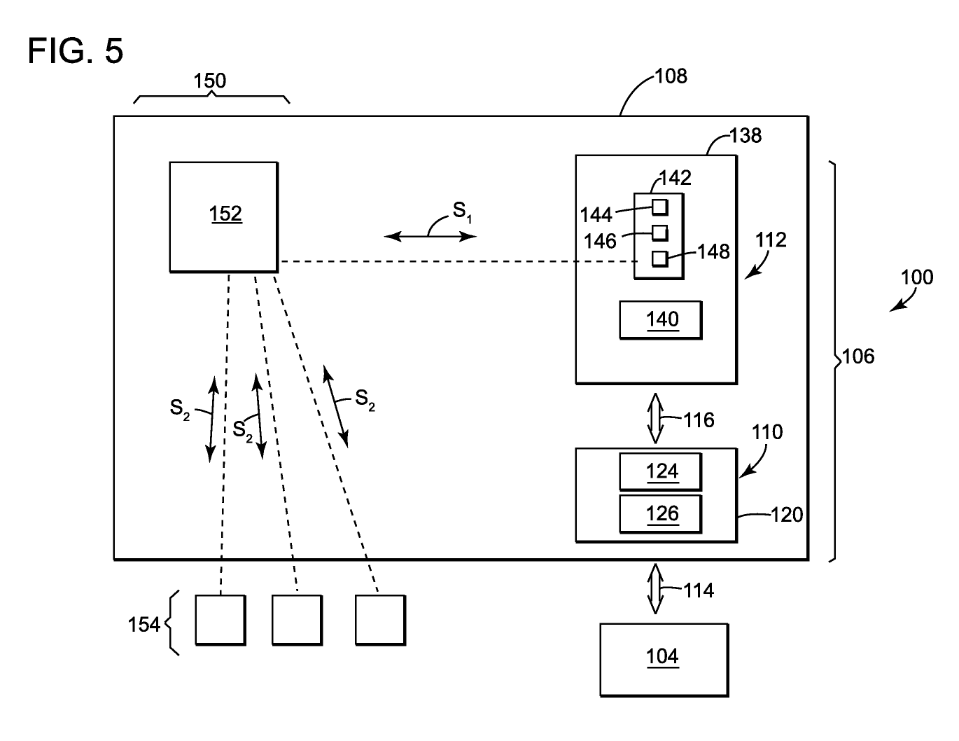

FIG. 5 depicts a schematic diagram of an example of the functional board 100 with additional components that add to its functionality. The second card 112 may embody a communication card 138 with a controller 140 and a connection unit 142, shown here to include one or more connection devices, like a USB connector 144 or a NFC tag 146. The connections devices 144, 146 can allow devices, like a laptop or smartphone, to exchange data with the functional board 100. Examples of the controller 140 may include computing components (like components 128, 130, 132 discussed above). These components are useful to “schedule” activities, for example, data collection from other parts on or of the functional board 100. In one implementation, the connection card 138 may also include a serial connection 148. Examples of the serial connection 148 may connect the communication card 138 with an auxiliary device 150. In use, the serial connection 148 may accommodate a signal S₁ that is useful to exchange data between the connection card 138 and the auxiliary device 150. The auxiliary device 150 may include a board 152 that exchanges data with one or more sensors 154. Examples of the sensors 154 can generate signals S₂ in response to conditions (like pressure or temperature) at or proximate the hardware 102. Preferably, signals S₁, S₂ may adopt the native language (or first protocol), but this does not need to be the case. The board 152 may process signals S₂ to arrive at values that transit to the communication card 138 as the signal S₁. For utility meters, the board 152 and sensors 154 may form a “volume corrector” that can adjust or correct measurements for volumetric flow rate of material through the device. Both the communication card 138 and the board 152 may co-locate on the main board 108, which itself may comprise appropriate interconnects to allow signal S₁ from the board 152 to transit to the communication card 138. If necessary, the controller 140 may also be configured with circuitry (like translator 124) to convert this data of signal S₁ into the first protocol (e.g., CoAP), after which it can transmit to the adapter 120 via the second signal 116. As noted herein, the translator 124 may convert the data from the first protocol to the second protocol for broadcast as the outgoing first signal 114 via the interface unit 126.

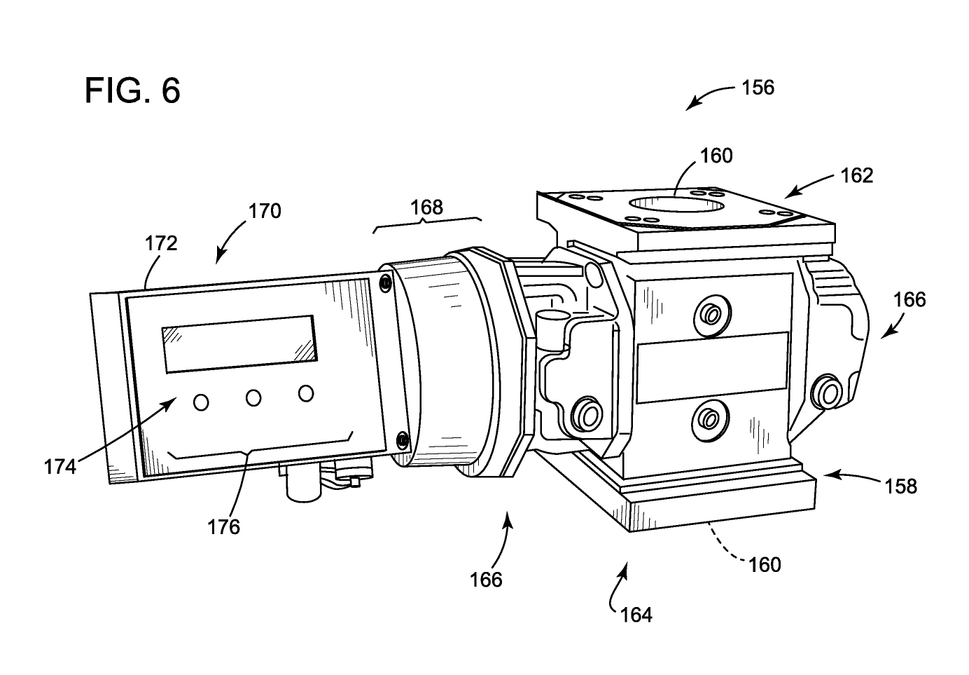

FIG. 6 depicts a perspective view of exemplary structure for the device 102 that can accommodate the functional board 100 of FIG. 5. This structure may embody a gas meter 156. The gas meter 156 may include a meter body 158, typically of cast or machined metals. The meter body 158 may form an internal pathway that terminates at openings 160 with flanged ends (e.g., a first flanged end 162 and a second flanged end 164). The ends 162, 164 may couple with complimentary features on a pipe or pipeline to locate the meter body 158 in-line with a conduit that carries material, often fluid hydrocarbons like natural gas or oil. As also shown, the meter body 158 may have a covers 166 disposed on opposing sides of the device. The covers 166 may provide access to the flowpath, where a pair of impellers resides inside so as to have access to the flow of material that passes through openings 158. Notably, the structure may accommodate other mechanics, like a diaphragm, or electronics for this purpose. One of the covers 166 may feature a connection 168, possibly flanged or prepared to interface with an electronics unit 170, shown here with an index housing 172 having an end that couples with the connection 168. The index housing 172 may comprise plastics, operating generally as an enclosure to contain and protect electronics including the functional board 100 (discussed above). The index housing 172 may support a display 174 and user actionable device 176, for example, one or more depressable keys an end user uses to interface with interior electronics to change the display 174 or other operative features of the device.

In light of the foregoing discussion, the improvements herein can make industrial hardware much more flexible to accommodate different applications. The embodiments may reduce costs as less time is spent to design (or re-design) circuitry that permits industrial hardware, like utility meters, valves, or actuators, to communicate with other devices. The concepts also allow manufacturers (and operators) to re-purpose such hardware more easily and without delays that often accompany safety certification of new designs. Likewise, these manufacturers can reduce inventory or other overhead because changes from model to model require only one replaceable part, essentially a replaceable “translator” card that inserts and removes from the underlying functional board to adapt the industrial hardware to communicate on different control systems, computing devices, or like end user preferred modality to exchange data. This replaceable “translator” car is configured with hardware and software (or executable instructions) to convert between data protocols. A technical effect is to outfit the hardware in a way to make hardware compatible to exchange data with different devices or control systems.

Computing components (e.g., memory and processor) can embody hardware that incorporates with other hardware (e.g., circuitry) to form a unitary and/or monolithic unit devised to execute computer programs and/or executable instructions (e.g., in the form of firmware and software). As noted herein, exemplary circuits of this type include discrete elements such as resistors, transistors, diodes, switches, and capacitors. Examples of a processor include microprocessors and other logic devices such as field programmable gate arrays (“FPGAs”) and application specific integrated circuits (“ASICs”). Memory includes volatile and non-volatile memory and can store executable instructions in the form of and/or including software (or firmware) instructions and configuration settings. Although all of the discrete elements, circuits, and devices function individually in a manner that is generally understood by those artisans that have ordinary skill in the electrical arts, it is their combination and integration into functional electrical groups and circuits that generally provide for the concepts that are disclosed and described herein.

This written description uses examples to disclose the invention, including the best mode, and also to enable any person skilled in the art to practice the invention, including making and using any devices or systems and performing any incorporated methods. An element or function recited in the singular and proceeded with the word “a” or “an” should be understood as not excluding plural said elements or functions, unless such exclusion is explicitly recited. References to “one embodiment” of the claimed invention should not be interpreted as excluding the existence of additional embodiments that also incorporate the recited features. Furthermore, the claims are but some examples that define the patentable scope of the invention. This scope may include and contemplate other examples that occur to those skilled in the art. Such other examples are intended to be within the scope of the claims if they have structural elements that do not differ from the literal language of the claims, or if they include equivalent structural elements with insubstantial differences from the literal language of the claims.

Examples appear below that include certain elements or clauses one or more of which may be combined with other elements and clauses to describe embodiments contemplated within the scope and spirit of this disclosure.

What is claimed is:

1. A utility meter, comprising:
a circuit board; and
a pair of circuit cards coupled to the circuit board to communicate with one another using a first communication protocol, at least one of the pair of circuit cards removable from the circuit board and comprising an interface unit that transmits and receives incoming signals in a second communication protocol that is different from the first communication protocol.

2. The utility meter of claim 1, further comprising:
a translator unit comprising a processor, memory, and executable instructions stored on memory, the executable instructions configuring the processor to convert the first protocol to the second protocol.

3. The utility meter of claim 2, wherein the translator unit is removable from the circuit board.

4. The utility meter of claim 1, further comprising:
a translator unit comprising a processor, memory, and executable instruction stored on memory, the executable instruction configuring the processor to convert the second protocol to the first protocol.

5. The utility meter of claim 4, wherein the translator unit is removable from the circuit board.

6. The utility meter of claim 1, further comprising:
a meter body with openings having flanged ends; and
an electronics unit coupled with the meter body, the electronics unit having an index housing,
wherein the circuit board resides in the index housing.

7. The utility meter of claim 1, further comprising:
an auxiliary device coupled with the circuit board, the auxiliary device communicating with the pair of circuit cards using the first protocol.

8. The utility meter of claim 1, wherein the interface unit comprises a wireless device.

9. The utility meter of claim 1, wherein the interface unit comprises a connector to receive signals in an industrial automation protocol.

10. The utility meter of claim 1, wherein the first protocol comprises Constrained Application Protocol (“CoAP”).

11. Industrial hardware, comprising:
a main circuit board;
a first card coupled to the main circuit board; and
a second card removeably replaceable from the main circuit board and capable of exchanging data with the first card using a first data format,
wherein the second card has a processor with access to executable instructions that configured the processor to covert data from the first data format to a second data format that is different from the first data format.

12. The industrial hardware of claim 11, wherein the first card is fixed to the main circuit board.

13. The industrial hardware of claim 11, wherein the second card has an antenna coupled with the processor to receive and broadcast data in the second data format.

14. The industrial hardware of claim 11, wherein the second card has a connector coupled with the processor to receive and broadcast data in the second data format

15. The industrial hardware of claim 11, wherein the first protocol comprises Constrained Application Protocol (“CoAP”).

16. The industrial hardware of claim 11, wherein the second protocol comprises one of HART, MODBUS, FOUNDATION Fieldbus, or PROFIBUS.

17. A method, comprising:
generating data on metrology hardware that corresponds with properties of a fluid;
exchanging the data in a first protocol between a first circuit card and a second circuit card;
converting the data at the first circuit card from the first protocol to a second protocol that is different from the second protocol; and
broadcasting the data from the first circuit card in the second protocol remote from the metrology hardware.

18. The method of claim 17, wherein the first protocol comprises Constrained Application Protocol (“CoAP”) and the second protocol comprises one of HART, MODBUS, FOUNDATION Fieldbus, or PROFIBUS.

19. The method of claim 17, wherein the first protocol comprises Constrained Application Protocol (“CoAP”) and the second protocol comports with wireless transmission of data.

20. The method of claim 17, further comprising:
changing the second protocol by replacing one of the pair of circuit cards.
